(19) United States
(12) Patent Application Publication
(10) Pub. No.: US 2001/0013435 A1
(43) Pub. Date: Aug. 16, 2001

(54) SELF-PROPELLED VEHICLE

(76) Inventor: KENJI ONO, URAWA-SHI (JP)

Correspondence Address: STEPHEN P BURR, BURR & BROWN, P.O. BOX 7068, SYRACUSE, NY, 13261-7068, US

(21) Appl. No.: 09/091,788

(22) PCT Filed: Dec. 27, 1996
(86) PCT No.: PCT/JP96/03889

§ 371 Date: None

(30) Foreign Application Priority Data
Dec. 28, 1995 (JP) 7/35475

(51) Int. Cl. B62D 51/04

(52) U.S. Cl. 180/19.2

(57) ABSTRACT

A self-propelled vehicle which is modeified to a truck capable of conveying a cargo so that it conveys a predetermined quantity of cargoes and which can be used for various applications. This vehicle includes a driving portion (11) and a steering portion (12), can move back and forth, can convey cargoes (35 and 36) and people (32) to be conveyed, and is driven by operator (30)on the vehicle. When the self-propelled vehicle (10) is moved back, the operator (30) can use it as a truck by operating the steering portion (12) without getting on the viecle.

### TECHNICAL FIELD

The present invention relates to a self-propelled vehicle and, more particularly, to a self-propelled vehicle for an operator to ride and move thereon and for a cargo or a person to be conveyed.

### BACKGROUND ART

In the prior art and in various fields, there have been used a three- or four-wheeled electric self-propelled vehicle for an operator to ride and move thereon while conveying a cargo.

This self-propelled vehicle has been widely employed in the prior art for the caring purpose to convey an aged or partially handicapped person or for an operator to convey a small quantity of cargo in an indoor or outdoor working site or the like.

However, what can be done by this self-propelled vehicle of the prior art is to convey a small quantity of cargo in addition to the operator but not to convey a predetermined amount or more cargo.

On the other hand, the self-propelled vehicle of the prior art can be used only when the operator rides to operate it, but cannot be used as a truck for conveying only a cargo, so that its application is restricted.

Therefore, the invention as set forth in claim 1 has an object to provide a self-propelled vehicle which is enabled to convey the predetermined quantity of or more cargo and to be used for various applications by making it as a truck for conveying a cargo.

In addition to the technical target of the invention as set forth in claim 1, moreover, the invention as set forth in claim 2 has an object to provide a self-propelled vehicle which comprises a front wheel portion and a truck portion.

In addition to the technical target of the invention as set forth in claim 2, moreover, the invention as set forth in claim 3 has an object to provide a self-propelled vehicle which can convey easily.

In addition to the technical target of the invention as set forth in claim 1 or 2, moreover, the invention as set forth in claim 4 has an object to provide a self-propelled vehicle which can be easily operated by equipping the steering portion with a bar handle.

In addition to the technical target of the invention as set forth in claim 4, moreover, the invention as set forth in claim 5 has an object to provide a self-propelled vehicle which can also be used as a truck.

In addition to the technical target of the invention as set forth in claim 5, moreover, the invention as set forth in claim 6 has an object to provide a self-propelled vehicle which can be used as the truck by changing the operating direction of the bar handle easily.

In addition to the technical target of the invention as set forth in claim 1, 2, 3, 4, 5 or 6, moreover, the invention as set forth in claim 7 has an object to provide a self-propelled vehicle which is easily ridden by the operator and which can convey a person.

In addition to the technical target of the invention as set forth in claim 1, 2, 3, 4, 5 or 6, moreover, the invention as set forth in claim 8 has an object to provide a self-propelled vehicle which is not restricted in the seated position of the person to be conveyed, while facilitating the getting on and off.

In addition to the technical target of the invention as set forth in claim 1, 2, 3, 4, 5 or 6, moreover, the invention as set forth in claim 9 has an object to provide a self-propelled vehicle which can convey a more massive cargo.

In addition to the technical target of the invention as set forth in claim 1, 2, 3, 4, 5, 6, 7, 8 or 9, moreover, the invention as set forth in claim 10 has an object to provide a self-propelled vehicle which can be easily operated for the backward run as the truck by the operator.

In addition to the technical target of the invention as set forth in claim 1, moreover, the invention as set forth in claim 11 has an object to provide an electric self-propelled vehicle which can be made lighter than that of the prior art.

In addition to the technical target of the invention as set forth in claim 1, moreover, the invention as set forth in claim 12 has an object to provide a self-propelled vehicle which can make a small turn while running.

### DISCLOSURE OF THE INVENTION

In order to solve such technical targets, according to the invention as set forth in claim 1, there is provided a self-propelled vehicle 10 comprising a driving portion 11 and a steering portion 12 so that it can be driven to run forward and backward to convey cargoes 35 and 36 and a passenger 32 and can be operated by an operator riding thereon, wherein the self-propelled vehicle 10 can be used for the backward run as a truck by operating it by the operator 30 not riding thereon.

According to the invention as set forth in claim 1, therefore, the self-propelled vehicle 10 can run forward and backward so that it can convey a predetermined quantity of cargo for the forward run with the operator riding thereon and can be used for the backward run as the truck to convey more massive cargoes 35 and 36 with the operator not riding thereon.

As a result, the self-propelled vehicle 10 can be operated for the forward run by the operator riding thereon and can be used for the backward run as the truck by the operator not riding on the vehicle.

According to the invention as set forth in claim 1, therefore, the self-propelled vehicle 10m can be used as the truck capable of conveying the predetermined quantity of or more cargo so that it can be used for the various applications.

According to the invention as set forth in claim 2, the self-propelled vehicle 10 comprises a front wheel portion 39 and a truck portion 37, wherein the driving portion 11 and the steering portion 12 are disposed at the front wheel portion 39, in that the front wheel portion 39 is disposed at the front end portion of the truck portion 37.

As a result, in addition to the technical target of the invention as set forth in claim 1, according to the invention as set forth in claim 2, there is provided the self-propelled vehicle comprising the front wheel portion 39 and the truck portion 37.

In addition to the technical target of the invention as set forth in claim 2, moreover, the invention as set forth in claim 3 comprises the front wheel portion 39 is made removable with respect to the truck portion 37.

According to the invention as set forth in claim 3, therefore, the front wheel portion 39 can be removed from the truck portion 37.

As a result, according to the invention as set forth in claim 3, the self-propelled vehicle 10 can be easily transported on an automobile, for example. Since the removed front wheel portion 39 has the driving portion 11, moreover, the front wheel portion 39 can be employed for another application by attaching it to another conveying means such as a wheeled chair.

In addition to the technical target of the invention as set forth in claim 1 or 2, moreover, the invention as set forth in claim 4 is comprises the steering portion 12 is equipped with a bar handle 21.

According to the invention as set forth in claim 4, therefore, the operator 30 drives the self-propelled vehicle 10 by gripping the bar handle 21 to operate the vehicle.

As a result, in addition to the effect of the invention as set forth in claim 1, according to the invention as set forth in claim 4, there is provided the self-propelled vehicle 10 which can be easily operated by the bar handle 21.

The invention as set forth in claim 5 comprises the bar handle 21 is reversely turned toward the front wheel 15.

In this case, the bar handle 21 may be turned back either horizontally or vertically.

According to the invention as set forth in claim 5, therefore, for the backward run, the operator 30 operates the self-propelled vehicle 10 by turning the bar handle 21 toward the front wheel 15, by getting off the self-propelled vehicle 10 and by gripping the bar handle 21 at a position from the front of the front wheel 15.

As a result, in addition to the effect of the invention as set forth in claim 2, according to the invention as set forth in claim 5, for the backward run, the direction to operate the bar handle 21 as the steering portion 12 of the self-propelled vehicle 10 can be easily changed.

The invention as set forth in claim 6 comprises the bar handle 21 includes: handle stems 24 and 24 arranged at the upper end of a front wheel suspending portion 38, as arranged at the front wheel 15, and so fixed to the front wheel suspending portion 38 as to be turned to rise and fall longitudinally of the self-propelled vehicle 10; and a handle bar 25 fixed to the end portions of the handle stems 24 and 24 generally at a right angle with respect to the handle stems 24 and 24, and in that the bar handle 21 is arranged for the forward run on the back side of the front wheel 15 and for the backward run far in front of the front wheel 15.

According to the invention as set forth in claim 6, therefore, the operator 30 brings down the bar handle 21 together with the handle stems 24 and 24 forward by a predetermined angle over the front wheel suspending portion 38. In this case, the bar handle 21 is arranged far in front of the front wheel 15 so that the operator 30 can use the self-propelled vehicle 10 as the truck by operating the bar handle 21 from the side of the front end portion 28 to drive the self-propelled vehicle 10 backward.

As a result, in addition to the effect of the invention as set forth in claim 3, according to the invention as set forth in claim 6, the direction to operate the bar handle 21 can be easily changed.

The invention as set forth in claim 7 comprises a seat 18 having arm rests 29, 29 and formed to seat the operator thereon for the forward run and to be swiveled to turn its seating direction for the backward run, so that it can convey a person other than the operator in a seated position for the backward run.

According to the invention as set forth in claim 7, therefore, the operator 30 can operate the self-propelled vehicle for the forward run while being seated on the seat 18, and can convey a person other than the operator 30 for the backward run while seating the person on the seat 18 and confronting the operator 30. In this case, moreover, the seat 18 can be reversed to convey the person in a position to look backward.

In addition to the effect of the invention as set forth in claim 1, 2, 3 or 4, according to the invention as set forth in claim 7, it is possible to provide a self-propelled vehicle which can also be used as the truck for conveying the person easily.

In addition to the effect of the invention as set forth in claim 1, according to the invention as set forth in claim 7, moreover, the seat 18 is equipped with the arm rests 29 and 29 so that the body can be supported by the arm rests 29 and 29 even when the vehicle makes a turn while running, for example. As a result, the partially handicapped or aged person can be conveyed safely on board.

The invention as set forth in claim 8 comprises the seat is made horizontally turnable by 360 degrees and can be properly fixed at a desired angular position so that it can convey the person other than the operator for the backward run while confronting or not the operator.

In addition to the effect of the invention as set forth in claim 1, 2, 3, 4, 5 or 6, according to the invention as set forth in claim 8, therefore, the seat can be horizontally turned by 360 degrees so that the person to be conveyed can be conveyed in a position facing in a desired direction.

Another effect is that the person to be conveyed can easily get on and off because the seat can be oriented in the direction for the getting on an doff. This is advantageous especially in case when the person is aged or handicapped.

The invention as set forth in claim 9 further comprises a supporting bar 33 made removable for supporting the operator 30 riding in a standing position from the back.

According to the invention as set forth in claim 9, therefore, the seat 18 is replaced by the supporting bar 33 so that the operator can drive in the standing position. This makes it possible to convey the more massive cargoes 35 and 36 than that of the case in which the self-propelled vehicle 10 is provided with the seat 18.

Since the supporting bar 33 is made removable, moreover, it can be removed for the backward run to convey the more massive cargoes 35 and 46.

As a result, in addition to the effect of the invention as set forth in claim 1, 2, 3 or 4, according to the invention as set forth in claim 9, there is achieved an effect that the more massive cargoes 35 and 36 can be conveyed.

The invention as set forth in claim 10 comprises the self-propelled vehicle is self-propelled at a speed substantially equal to the humane walking speed.

According to the invention as set forth in claim 10, therefore, when the operator 30 operates the drive of the self-propelled vehicle 10 for the backward run on the side of the front end portion 28 by using the bar handle 21 while not riding, the operator 30 can walk in conformity with the speed of the self-propelled vehicle 10 while operating the self-propelled vehicle 10.

As a result, in addition to the effect of the invention as set forth in claim 1, 2, 3, 4, 5 or 6, according to the invention as set forth in claim 10, it is possible to provide a self-propelled vehicle 10 which can be easily used as the truck by the operator 30.

The invention as set forth in claim 11 comprises the driving portion 11 is composed of an electric motor 19, and in that a power supply to be supplied to the driving portion 11 is formed to have a small capacity.

According to the invention as set forth in claim 11, therefore, the battery 20 for energizing the electric motor 19 acting as the driving portion 11 is formed to have a small capacity so that the weight of the battery 20 can be reduced to simplify the structure of the body.

As a result, in addition to the effect of the invention as set forth in claim 1, according to the invention as set forth in claim 11, it is possible to provide an electric self-propelled vehicle 10 which does not have a large weight.

The invention as set forth in claim 12 comprises one front wheel at its front end portion and two rear wheels at its rear end portion and is characterized in that the driving portion drives the front wheel.

As a result, according to the invention as set forth in claim 12, even when the front wheel 15 is directed generally at a right angle with respect to the running direction, the direction to drive the front wheel 15 can be changed at a steering time.

As a result, in addition to the effect of the invention as set forth in claim 1, according to the invention as set forth in claim 12, it is possible to provide a self-propelled vehicle 10 which can make a very small turn at the running time.

### BRIEF DESCRIPTION OF DRAWINGS

FIG. 1 is schematic diagram showing one mode of embodiment of a self-propelled vehicle according to the invention and illustrates the case in which the vehicle is driven to run forward by an operator seated on its seat; FIG. 2 is a perspective view showing the mode of embodiment of the self-propelled vehicle according to the invention and illustrates a bar handle and a driving portion of a front wheel, namely, the state of the bar handle in the forward run; FIG. 3 is a perspective view showing the mode of embodiment of the self-propelled vehicle according to the invention and illustrates the bar handle and the driving portion of the front wheel, namely, the state of the bar handle in the backward run; FIG. 4 is a schematic diagram showing the mode of embodiment of the self-propelled vehicle according to the invention and illustrates the case in which the self-propelled vehicle is used as a truck so that a person to be conveyed is seated to face the operator when the vehicle is driven backward; FIG. 5 is a schematic diagram showing the mode of embodiment of the self-propelled vehicle according to the invention and illustrates the case in which the self-propelled vehicle is used as a truck so that a person to be conveyed is seated to look forward when the vehicle is driven backward; FIG. 6 is a schematic diagram showing another mode of embodiment of the self-propelled vehicle according to the invention and illustrates the case in which the self-propelled vehicle is equipped with a supporting bar in place of the seat so that it is driven forward by a standing operator while conveying a cargo; FIG. 7 is a schematic diagram showing the other mode of embodiment of the self-propelled vehicle according to the invention and illustrates the case in which the self-propelled vehicle is used as a truck by eliminating the supporting bar so that it is driven backward to convey a cargo by an operator standing on the front end side of the vehicle; and FIG. 8 is a schematic diagram showing the other mode of embodiment of the self-propelled vehicle according to the invention and illustrates the case the self-propelled vehicle is driven forward by an operator seated on a seat having no rest.

### BEST MODE FOR CARRYING OUT THE INVENTION

The self-propelled vehicle according to the invention will be described on the best mode for carrying out the invention with reference to the accompanying drawings.

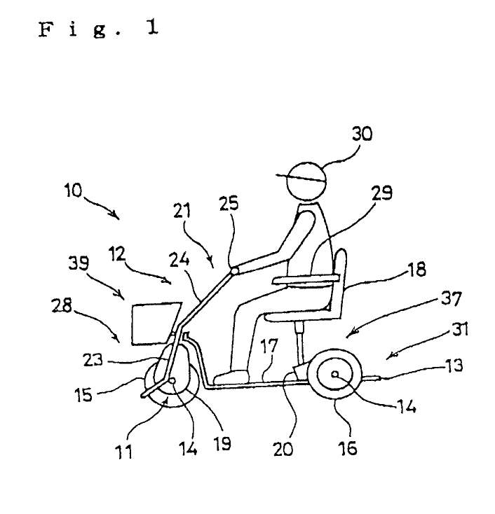

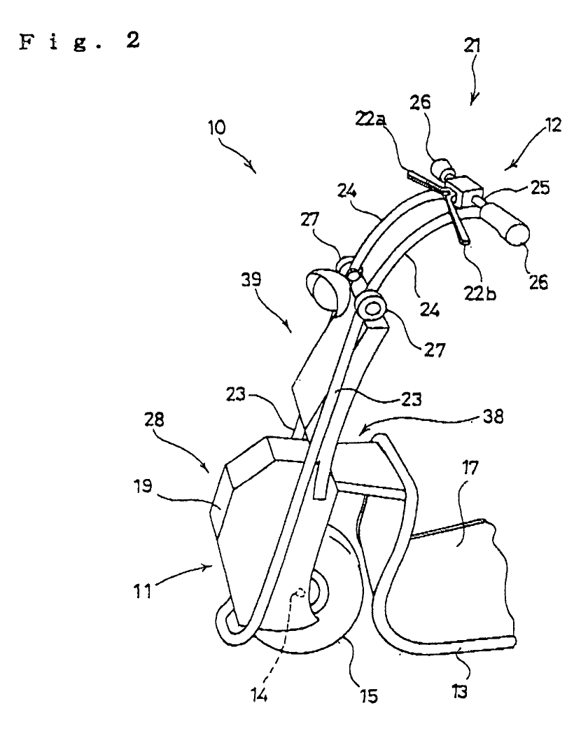

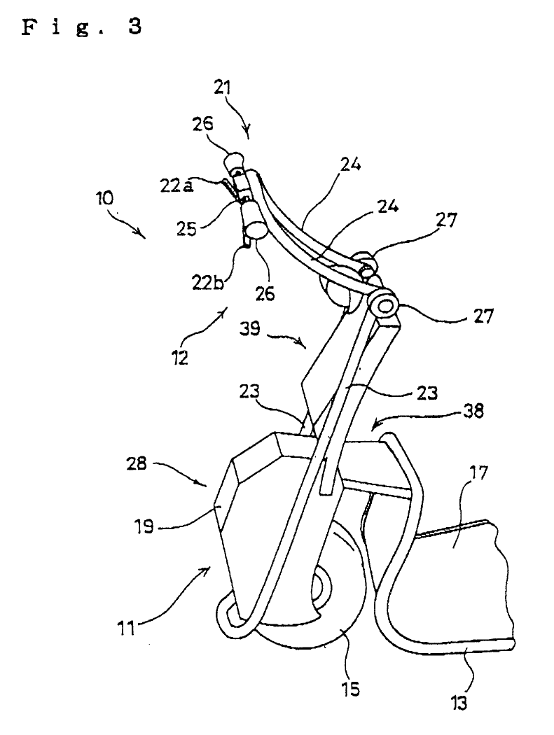

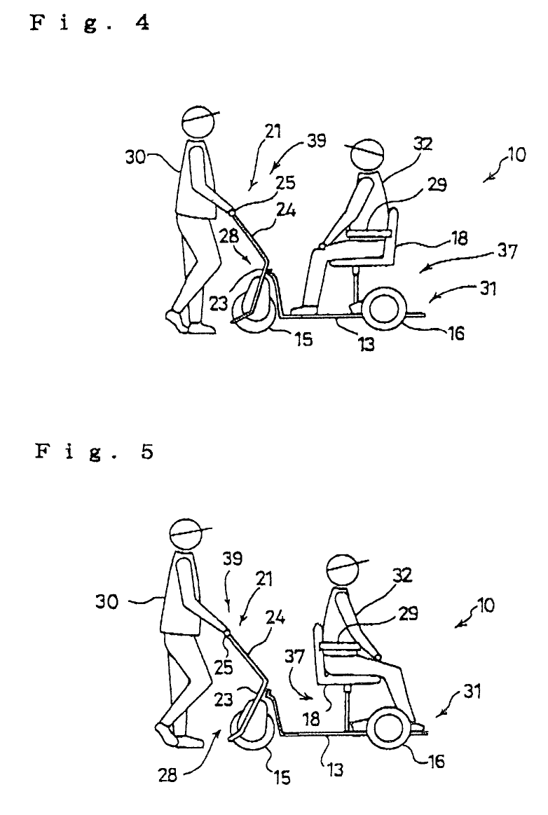

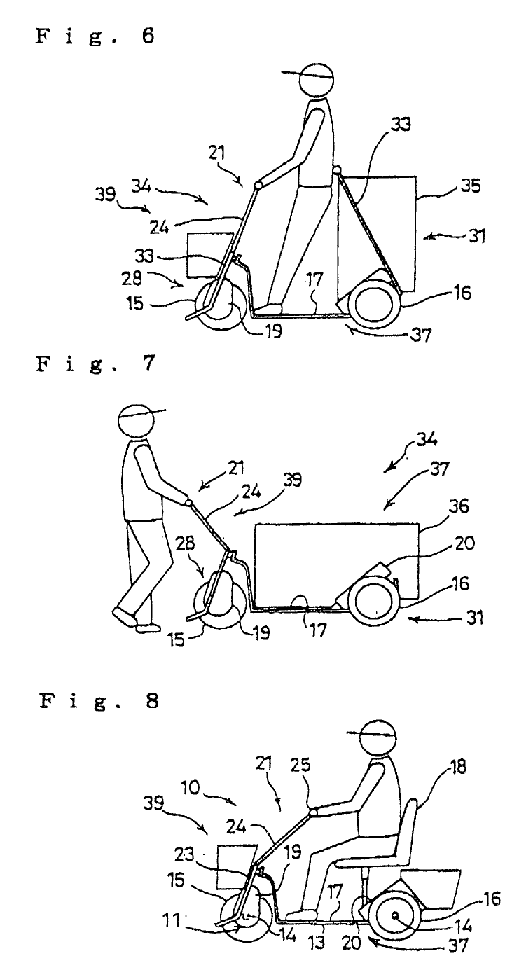

As shown in FIG. 1, a self-propelled vehicle 10 according to the present mode of embodiment is constructed to comprise a driving portion 11 and a steering portion 12 and to be driven to run back and forth to convey a cargo and a person by an operator riding thereon. The self-propelled vehicle 10 is enabled to run backward as a truck when its steering portion 12 is operated by the operator without riding thereon.

Specifically, the self-propelled vehicle 10 according to the present mode of embodiment is formed into a three-wheeled electric car having one front wheel and two rear wheels. The self-propelled vehicle 10 is equipped with a frame 13 made of a pipe, a front wheel 15 arranged at the front end portion of the frame through an axle 14, two rear wheels 16 and 16 arranged at the rear end portion of the frame 13 through an axle 14, a floor panel 17 fixed on the frame 13, and a seat 18 for the operator to seat thereon.

The self-propelled vehicle 10 according to the present mode of embodiment is equipped with a front wheel portion 39 and a truck portion 37. The driving portion 11 and the steering portion 12 are disposed at the front wheel portion 39. This front wheel portion 39 is disposed at the front end portion of the truck portion 37 such that it is made removable from the truck portion 37.

The driving portion 11 is composed of an electric motor 19, which is fixed on the axle 14 of the front wheel, and a battery 20 for supplying an electric power to the electric motor 19 is arranged over the axles 14 of the rear wheels 16 and 16. The battery 20 is given a small capacity in the present mode of embodiment, and two batteries of 6.5 Kg are mounted to provide a far smaller weight than the battery of the prior art having a weight of 30 Kg.

On the other hand, the electric motor 19 can be steplessly changed in its speed by the not-shown control unit. When the operator grips and controls an accelerator lever 22 attached to a bar handle 21, as shown in FIG. 21, the electric power supply to the electric motor 19 can be suitably changed according to the degree of opening of the accelerator lever 22 thereby to change the running speed freely.

Moreover, the electric motor 19 can be reciprocally activated to run the self-propelled vehicle 10 forward and backward. In this case, the maximum speed is set at 6 Km/h for the forward run and at 4 Km/h for the backward run.

On the other hand, the front wheel portion 39 is equipped with a front wheel suspending portion 38 suspending the front wheel 15, and the bar handle 21 is attached to the upper end portion of the front wheel suspending portion 38. The bar handle 21 is equipped with: handle stems 24 and 24 which are so fixed to the front wheel suspending portion 38 as to be swung to rise and fall in the longitudinal direction; and a handle bar 25 which is fixed generally at a right angle to the end portions of the handle stems 24 and 24. The bar handle 21 is positioned for the forward run at the rear side of the front wheel 15 and for the backward run at the front side of the front wheel 15. Here, reference numerals 23 and 23 designate front frames which are made integral with the bumper.

On the other hand, the bar handle 21 has righthand and lefthand accelerator levers 22a and 22b made integral therewith. These accelerator levers 22a and 22b are fixed at their transverse center portion to the bar handle 21 through the (not-shown) spring member.

At the driving time, therefore, the operator rotates the electric motor 19 forward by gripping not only the grip portions 26 of the bar handle 21 but also the accelerator lever 22a, thereby to generate the driving force in the forward direction. When the lefthand accelerator lever 22b is gripped, the electric motor 19 is reversed to generate the driving force in the backward direction.

On the other hand, the bar handle 21 can be steplessly changed in its angle over the front wheel suspending portion 38 and can be suitably fixed at the set desirable angle.

As shown in FIGS. 2 and 3, more specifically, the handle stems 24 and 24 are individually fixed at their lower ends to hinged portions 27 and 27 which are provided at the upper end portion of the front wheel suspending portion 38. The handle stems 24 and 24 can be vertically turned to rise and fall longitudinally by about 180 degrees on the hinged portions 27 and 27.

Moreover, these hinged portions 27 can be fixed at a desired angle by the single action using the (not-shown) suitable means.

For the forward run of the self-propelled vehicle 10 according to the present mode of embodiment, therefore, the bar handle 21 can be suitably fallen toward the rear wheels 16 and 16, as shown in FIGS. 1 and 2. Then, the operator, as seated on the seat 18, can easily grip the bar handle 21 to steer and drive the vehicle.

For the backward run, on the other hand, the bar handle 21 is turned by a predetermined angle to fall down to the front side of the self-propelled vehicle 10 by the operator, as shown in FIG. 3. In this case, the bar handle 21 is positioned in front of the front wheel 15 so that the operator 30 can operate the bar handle 21 from the side of the front end portion 28 to the back of the self-propelled vehicle 10 thereby to employ the self-propelled vehicle 10 as a truck.

In this case, the present mode of embodiment is constructed to be self-propelled for the backward run at a speed (e.g., 4 Km/h) substantially equal to the humane walking speed, as described hereinbefore. At this backward run, the operator does not ride on the self-propelled vehicle 10 but grips the bar handle 21 on the side of the front end portion 28 and operates the self-propelled vehicle 10 toward the rear end portion 31 of the vehicle 10. Then, the operator can walk while operating the self-propelled vehicle 10 in conformity to the speed of the vehicle 10.

As shown in FIGS. 1, 4 or 5, on the other hand, the seat 18 can be horizontally swiveled by 360 degrees and fixed at a position of a desired suitable angle. For the backward run, a person other than the operator can be conveyed while confronting the operator.

In the self-propelled vehicle 10 according to the present mode of embodiment, therefore, the seat 18 can be seated for the forward run by the operator 30 and can be turned for the backward run to the reverse seating position.

Moreover, this seat 18 can be horizontally swiveled by 360 degrees so that the person can be conveyed in the seated position while looking in a desired direction.

Moreover, the person to be conveyed finds it easy to get on/off because the seat can be oriented in any direction. This easiness is advantageous especially when the person is aged or handicapped.

On the other hand, the seat 18 is equipped at its two side portions with arm rests 29 for conveying the person other than the operator in the seated position for the backward run.

Here will be described the actions of the self-propelled vehicle 10 according to the present mode of embodiment.

When the self-propelled vehicle 10 according to the present mode of embodiment is to be run by the single operator 30 riding thereon, the operator seats himself on the seat 18, as shown in FIG. 1. Then, the operator 30 falls down the bar handle 21 toward the rear end portion of the self-propelled vehicle 10 and fixes it at a proper angle so that the operator 30 may be able to operate the bar handle 21 in the seated position on the seat 18.

Then, the operator 30 takes the seated position on the seat 18 and grips not only the grip portions 26 of the bar handle 21 but also the accelerator lever 22a. When the righthand accelerator lever 22a is gripped, the speed can be steplessly changed according to the accelerator opening, as described hereinbefore, so that the driving force of the electric motor 19 is applied to the front wheel 15 to run the self-propelled vehicle 10 forward.

When the self-propelled vehicle 10 is to be turned to the right or left, on the other hand, the operator can turn the bar handle 21 to the right or left. In the present mode of embodiment, moreover, the self-propelled vehicle is formed into the three-wheeled vehicle and is equipped with the electric motor 19 at its front wheel 15, as described hereinbefore, so that it is constructed into the so-called “front wheel drive”. Even when the front wheel 15 is directed generally at a right angle in the forward direction, for example, the self-propelled vehicle is driven at its front wheel 15 so that it can turn its direction at the position on the rear wheels 16.

When the self-propelled vehicle 10 is to be stopped, on the other hand, the accelerator lever 22a is released from its gripped state. Then, the driving force is not applied to the front wheel 15 so that the self-propelled vehicle 10 runs a predetermined distance before it is naturally stopped. Here, the self-propelled vehicle 10 according to the present mode of embodiment is completely stopped at a distance of about 1 m when the accelerator lever 22a is released while the vehicle is running at 6 Km/h.

When the self-propelled vehicle 10 according to the present mode of embodiment is to be used as the truck, the operator 30 brings the bar handle 21 down by a predetermined angle to the front of the vehicle, as shown in FIG. 3. Then, the bar handle 21 is positioned in front of the front wheel 15 so that the operator 30 is enabled to use the self-propelled vehicle 10 as the truck by operating the bar handle 21 from the side of the front end portion 28 of the self-propelled vehicle 10.

In this case, the bar handle 21 is positioned far in front of the front wheel 15 of the self-propelled vehicle 10. This positioning prevents the feet of the operator 30 from being obstructed for the conveying operation by the front wheel 15, when the operator 30 gets off the self-propelled vehicle 10, goes to the front of the front wheel 15 and grips the bar handle 21 for the backward run while facing the rear end portion 31 of the self-propelled vehicle 10.

When the self-propelled vehicle 10 is driven backward so that it may be used as the truck, the lefthand accelerator lever 22b of the bar handle 21 can be gripped to apply the driving force to the front wheel 15 so that the self-propelled vehicle 10 can run back to the rear end portion 31. In this case, a person 32 to be conveyed can also be seated on the seat 18, as left in the position for the forward run, as shown in FIG. 4, and can be conveyed while confronting the operator 30. Moreover, the seat 18 can be reversed backward, as shown in FIG. 5, to convey the person 32 thereon. When the person 32 is to get on and off, still moreover, the seat 18 can be turned in a suitable direction and fixed at such an angle as to allow the person 32 to get on and off easily.

In the present mode of embodiment, on the other hand, the seat 18 is equipped with the arm rests 29 and 29 so that the person 32 seated on the seat 18 can be supported by the arm rests 29 even when the self-propelled vehicle 10 makes a sharp turn. As a result, the self-propelled vehicle 10 according to the present mode of embodiment can convey even a partially handicapped or aged person safely in a state conforming to the regulations.

Therefore, the self-propelled vehicle 10 according to the present mode of embodiment is properly employed for taking care of the partially handicapped or aged person.

On the other hand, the present mode of embodiment has been described in connection with the self-propelled vehicle 10 which is equipped with the seat 18 to be seated by the operator or the person to be conveyed. However, the invention should not be limited to that mode of embodiment but may be modified by eliminating the seat 18 such that a removable supporting bar 33 is provided to extend obliquely upward from the rear end portion of the frame 13 to the side of the front end portion 28 of the self-propelled vehicle, as shown in FIG. 6.

When the self-propelled vehicle 34 thus constructed is to be operated, the operator 30 drives it while standing on the floor panel 17 with his waist against the supporting bar 33.

With this construction, a large cargo 35 can be conveyed on the space which is otherwise occupied by the seat 18. According to the present mode of embodiment, moreover, the supporting bar 33 can be removed for the backward run, as shown in FIG. 7, so that a large-sized cargo 36 can be conveyed by making use of the substantially entire area of the floor panel 17.

As a result, the self-propelled vehicle 34 according to the present mode of embodiment can convey the more passive cargo 36.

Here, the foregoing mode of embodiment has been described in connection with the case in which the vehicle is equipped with the three wheels. However, the invention should not be limited to the mode of embodiment but can be embodied by four wheels. Moreover, the invention has been described in connection with the case of the front-wheel drive, but the driving type should not be limited to the aforementioned mode of embodiment.

In the aforementioned mode of embodiment, moreover, the invention has been described in connection with the case in which the bar handle 21 is turned to rise and fall to the reverse direction. However, the invention should not be limited to the foregoing mode of embodiment but may be modified such that the front wheel suspending portion 38 is positioned upright and such that the bar handle 21 is turned horizontally back and forth on the front wheel suspending portion 38.

On the other hand, the foregoing mode of embodiment has been described in connection with the case in which the seat 18 to be seated by the operator 30 or the person 32 is equipped with the arm rests 29 and 29 on its two sides. However, the invention should not be limited to the aforementioned mode of embodiment but can be modified by eliminating the arm rests 29 and 29, as shown in FIG. 8.

On the other hand, the description thus far made is directed to the case in which the driving portion is constructed of the electric motor 19. However, the type of the driving portion should not be limited to that of the foregoing mode of embodiment but can employ an internal combustion engine.

On the other hand, there has been described the case in which the steering portion 12 is constructed of the bar handle 21. However, the steering portion 12 should not be limited to that of the foregoing mode of embodiment but may be constructed of a steering wheel.

On the other hand, the battery 20 of the present mode of embodiment employs two units of 6.5 Kg, which are lighter than the battery of 30 Kg of the prior art. This allows the frame 13 to have a strength sufficient for supporting the battery 20. In the prior art in which the battery of 30 Kg is mounted, the frame 13, the front wheel 15 and the rear wheels 16 have to be given a predetermined strength so that their total weight is as large as 80 Kg. The self-propelled vehicle 10 or 34 according to the present mode of embodiment has a total weight of 55 Kg, which is cut by 25 Kg from the total weight of the prior art. This weight cut provides an effect that the self-propelled vehicle 10 or 34 can be easily handled when it is mounted on an automobile.

In the self-propelled vehicle 10 or 34 according to the present mode of embodiment, on the other hand, the front wheel portion 39 is removably attached to the truck portion 37. This makes it possible to remove the front wheel portion 39 from the truck portion 37 and to transport them separately thereby to provide a self-propelled vehicle having an excellent transportability.

Since the front wheel portion 39 removed has the driving portion 11, on the other hand, it can be attached to the existing wheeled chair, for example, so that the wheeled chair can also be used as a self-propelled vehicle.

According to the invention as set forth in claim 1, as has been described hereinbefore, the self-propelled vehicle can be operated for the forward run by the operator riding thereon and can be used for the backward run as a truck by the operator not riding on the vehicle. This results in an effect that the self-propelled vehicle can be used as the truck capable of conveying a predetermined quantity of or more cargo so that it can be used for a variety of applications.

In addition to the effect of the invention as set forth in claim 1, according to the invention as set forth in claim 2, there is provided a self-propelled vehicle comprising a front wheel portion and a truck portion.

In addition to the effect of the invention as set forth in claim 2, according to the invention as set forth in claim 3, the self-propelled vehicle to be provided has an excellent transportability and can be jointed for use to the existing wheeled chair or the like so that it can retain a wide variety of applications.

In addition to the effect of the invention as set forth in claim 1 or 2, according to the invention as set forth in claim 4, there is provided a self-propelled vehicle which can be easily operated by a bar handle.

According to the invention as set forth in claim 5, the bar handle is reversed for the backward run to the front wheel so that the operator can operate the self-propelled vehicle by using the bar handle from the front wheel.

As a result, in addition to the effect of the invention as set forth in claim 4, there is achieved an effect that the direction to operate the bar handle as the steering portion of the self-propelled vehicle can be easily changed for the backward run.

According to the invention as set forth in claim 6, for the backward run, the operator brings down the bar handle together with the handle stems over the front wheel suspending portion to the front by the predetermined angle. Then, the bar handle is arranged far in front of the front wheel so that the operator is enabled to use the self-propelled vehicle as the truck by operating the bar handle from the side of the front end portion of the vehicle.

As a result, in addition to the effect of the invention as set forth in claim 5, according to the invention as set forth in claim 6, there is achieved an effect that the direction to operate the bar handle can be easily changed.

According to the invention as set forth in claim 7, for the forward run, the operator is seated to operate the self-propelled vehicle. For the backward run, on the other hand, a person other than the operator can be seated and conveyed while confronting the operator. In this latter case, moreover, the person to be conveyed can be conveyed while looking backward by reversing the seat.

In addition to the effect of the invention as set forth in claim 1, 2, 3, 4, 5 or 6, according to the invention as set forth in claim 7, therefore, it is possible to provide a self-propelled vehicle which can be easily ridden by the operator or easily used as a truck for conveying the person.

In addition to the effect of the invention as set forth in claim 1, 2, 3, 4, 5 or 6, according to the invention as set forth in claim 7, moreover, the driver can be supported at his body by the arm rests even when the vehicle turns a curve while running, so that a person having a partially handicapped body can be conveyed safely in the riding position.

According to the invention as set forth in claim 8, the seat can be turned by 360 degrees so that the direction for the person to seat himself while being conveyed is not limited. In addition to the effect of the invention as set forth in claim 1, 2, 3, 4, 5 or 6, therefore, the operator can convey the person while confronting him to confirm his condition. Moreover, the direction for the person to seat himself or to get on and off the vehicle is not restricted so that the person can easily get on and off the self-propelled vehicle.

According to the invention as set forth in claim 9, the seat is replaced by the supporting bar so that the operator can drive in a stand position. As a result, it is possible to convey more cargoes than the case in which the self-propelled vehicle is equipped with the seat. For the backward run, on the other hand, the supporting bar can be removed to convey more cargoes.

In addition to the effect of the invention as set forth in claim 1, 2, 3, 4, 5 or 6, according to the invention as set forth in claim 9, moreover, there is achieved an effect that more cargoes can be conveyed.

According to the invention as set forth in claim 10, the operator can walk along the self-propelled vehicle while operating it in conformity with the speed of the vehicle when he or she operates the self-propelled vehicle for the backward run without riding thereon by using the bar handle on the side of the front end portion.

As a result, in addition to the effect of the invention as set forth in claim 1, 2, 3, 4, 5, 6, 7, 8 or 9, according to the invention as set forth in claim 10, it is possible to provide a self-propelled vehicle for the operator to easily use as a truck for the backward run.

According to the invention as set forth in claim 11, it is possible to reduce the weight of the battery and to simplify the structure of the body. In addition to the effect of the invention as set forth in claim 1, it is possible to provide an electric self-propelled vehicle having no large weight.

According to the invention as set forth in claim 12, at a steering time, even when the front wheel is directed generally at a right angle with respect to the forward direction, the self-propelled vehicle can be turned because its front wheel is driven. In addition to the effect of the invention as set forth in claim 1, therefore, it is possible to provide a self-propelled vehicle capable of making a small turn while running.

### INDUSTRIAL APPLICABILITY

As has been described hereinbefore, the self-propelled vehicle according to the invention is suited for the application in which the operator himself operates the vehicle to run in a outdoor working side or the like, the application in which a cargo is to be conveyed on a truck portion, or the application in which a partially handicapped or aged person is to be conveyed on a truck so that he or she may be cared.

1. A self-propelled vehicle comprising a driving portion and a steering portion so that it can be driven to run forward and backward to convey cargoes and and a passenger and can be operated by an operator riding thereon, wherein the self-propelled vehicle can be used for the backward run as a truck by operating it by the operator not riding thereon.

2. A self-propelled vehicle as set forth in claim 1, further comprising a front wheel portion and a truck portion, wherein the driving portion and the steering portion are disposed at the front wheel portion, and in that the front wheel portion is disposed at the front end portion of the truck portion.

3. A self-propelled vehicle as set forth in claim 2, wherein the front wheel portion is made removable with respect to the truck portion.

4. A self-propelled vehicle as set forth in claim 1 or 2, wherein the steering portion is equipped with a bar handle.

5. A self-propelled vehicle as set forth in claim 4, wherein the bar handle is reversely turned toward the front wheel.

6. A self-propelled vehicle as set forth in claim 5, wherein the bar handle includes: handle stems arranged at the upper end of a front wheel suspending portion and so fixed to the front wheel suspending portion as to be turned to rise and fall longitudinally of the self-propelled vehicle; and a handle bar fixed to the end portions of the handle stems generally at a right angle with respect to the handle stems, and in that the bar handle is arranged for the forward run on the back side of the front wheel and for the backward run far in front of the front wheel.

7. A self-propelled vehicle as set forth in claim 1, 2, 3, 4, 5 or 6, further comprising a seat having arm rests and formed to seat the operator thereon for the forward run and to be swiveled to turn its seating direction for the backward run, so that it can convey a person other than the operator in a seated position for the backward run.

8. A self-propelled vehicle as set forth in claim 1, 2, 3, 4, 5 or 6, wherein the seat is made horizontally turnable by 360 degrees and can be properly fixed at a desired angular position so that it can convey the person other than the operator for the backward run while confronting or not the operator.

9. A self-propelled vehicle as set forth in claim 1, 2, 3, 4, 5 or 6, further comprises a supporting bar made removable for supporting the operator riding in a standing position from the back.

10. A self-propelled vehicle as set forth in claim 1, 2, 3, 4, 5, 6, 7, 8 or 9, wherein the self-propelled vehicle is self-propelled at a speed substantially equal to the humane walking speed.

11. A self-propelled vehicle as set forth in claim 1, whrerin the driving portion is composed of an electric motor, and in that a power supply to be supplied to the driving portion is formed to have a small capacity.

12. A self-propelled vehicle as set forth in claim 1, further comprising one front wheel at its front end portion and two rear wheels at its rear end portion, wherein the driving portion can drive the front wheel.
